(19) United States
(12) Patent Application Publication
(10) Pub. No.: US 2020/0160354 A1
(43) Pub. Date: May 21, 2020

(54) Article Attestation System Using Blockchain

(71) Applicant: 3M INNOVATIVE PROPERTIES COMPANY, St. Paul, MN (US)

(72) Inventors: James W. Howard, Circle Pines, MN (US); Siddhant Vashist, Plainsboro, NJ (US); Carlo D. Supina, Eagan, MN (US); Karl Battle, Woodbury, MN (US); Jonathan L. Diaz-Lopez, St. Paul, MN (US); James B. Snyder, Minneapolis, MN (US); James L.C. Werness, Jr., Edina, MN (US); Tien Yi T.H. Whiting, St. Paul, MN (US)

(21) Appl. No.: 16/634,753

(22) PCT Filed: Aug. 6, 2018
(86) PCT No.: PCT/IB2018/055910

§ 371 Date: Jan. 28, 2020

Related U.S. Application Data
(60) Provisional application No. 62/542,796, filed on Aug. 8, 2017.
(60) Provisional application No. 62/562,772, filed on Sep. 25, 2017.
(60) Provisional application No. 62/564,792, filed on Sep. 28, 2017.

(51) Int. Cl. G06Q 30/00; G06F 16/23; G06K 19/06

(52) U.S. Cl. CPC G06Q 30/0185; G06K 19/06037; G06K 19/06028; G06F 16/2379

(57) ABSTRACT

In some examples, an article may include a layer having a first surface marked with a first code. The article may include a second surface marked with a second code, the second code obscured by the layer to be unreadable through the layer. The first code and the second code may be associated in transaction data stored by a blockchain managed by a consensus network of nodes.

### TECHNICAL FIELD

The present application relates generally to systems and devices for attesting to the authenticity of articles.

### BACKGROUND

Counterfeiting is a perennial problem in the global supply chain. Some types of counterfeiting involve replacing authentic goods sent by a supplier at some point along the supply chain with counterfeits. The intended recipient receives the counterfeit goods, and the counterfeiter is able to sell the authentic goods on the open market.

As one example, because of counterfeit drugs and pharmaceutical crimes, an alarming amount of drugs all over the world are fake. Many times, the drugs have little to no active ingredients and in some cases can even be so toxic that they are injurious or even fatal. It is estimated that is a $200 billion market and that 10-30% of drugs all over the world are counterfeits. Most drug counterfeiting takes place along the supply chain, where fraudsters replace drugs and other products at carrier locations with fake ones that are almost indecipherable from the originals. Many times, even chemical scans are unable to discriminate between real and fake drugs. As a result, hundreds of people, just in the United States, die every year because of these fake drugs.

### SUMMARY

In general, the disclosure is directed to an auditable system of article attestation. For example, a supplier may mark, with multiple codes per article, articles requiring attestation by a final receiver. The supplier may register the codes to a blockchain. Recipients of an article, including all intermediaries along a supply chain for the article, may read the codes from the articles and register events to the blockchain network. A code may be a Quick Response (QR) or other machine-readable code, for instance. The final recipient may use the events registered to the blockchain to verify that an item protected by the article has not been tampered with.

In some examples, the article includes multiple surfaces each presenting a unique code. For instance, the article may be an adhesive article that has a top layer and a bottom layer, each layer having a unique machine-readable code printed thereon. When affixed to an item, the top layer of the article may be visible and machine-readable but the bottom layer may be obscured by the top layer. In some instances, the bottom layer may become embodied with the machine-readable code or the machine-readable code may be made machine-readable as a result of removal of the top layer from the bottom layer. In some instances, a single layer has a visible topside and an underside obscured by the topside, each of the topside and the underside having a unique machine-readable code printed thereon. The bottom layer or the underside layer in the above examples may be visible when the top layer (or the single layer) is removed from the article.

In some examples, for an article, the first machine-readable code of the top layer or topside may be scanned using readers along the supply chain by intermediaries (e.g., shippers/carriers) to register an event with respect to the article to the blockchain. In some cases, the intermediaries may also associate the events with their identifying information and respective operations, with respect to the article, to the blockchain. At final delivery, the final recipient may peel off the top layer (or the single layer) and use a reader to scan the second machine-readable code printed on the bottom layer (or underside) and may request attestation from the blockchain that each expected recipient received the item with the affixed article. If the blockchain includes transactions that do not match the expected transactions, this is evidence of tampering in the supply chain, and the final recipient may take an action to respond to the evidence.

For example, in instances in which recipients register events for the first machine-readable code to the blockchain, the recipient may further verify, using the distributed blockchain network, that, e.g., the article was scanned at each correct location at an appropriate time and can acquire the package with a fair amount of certainty that it is original and has not been tampered with. The article itself may be tamper-resistant to show signs of any tampering. Any suspicious physical signs or flags on the network can be audited to assess the authenticity of the package. The above-described techniques can also be done by the use of multiple layers instead of just one or two. At each step of a supply chain, the recipient can peel the layer to reveal the one below it and confirm the identity of the article using the machine-readable code printed thereon using the distributed blockchain network.

As such, a tamper-evident tape or label that combines a physical marking system using adhesive/low adhesion coating technology and a consensus network using blockchain technology, such as Ethereum and smart contracts, is described. Articles as described herein are auditable by carriers, recipients, and consumers of the articles according to the described techniques.

In one example, an article comprises a layer having a first surface marked with a first code; and a second surface marked with a second code, the second code obscured by the layer to be unreadable through the layer, wherein the first code and the second code are associated in transaction data stored by a blockchain managed by a consensus network of nodes.

In one example, an article comprises a layer having a first surface marked with a first code; and a second surface marked with a second code, the second code obscured by the layer to be unreadable through the layer.

In one example, a method comprises marking a first surface of a layer of an article with a first code; marking a second surface of the article with a second code, the second code obscured by the layer and unreadable through the layer; and sending, by a computing device via a network, the first code and the second code to register an association of the first code and the second code in a blockchain managed by a consensus network.

In one example, a method comprises receiving, by a consensus network, a first code and a second code, the first code marked on a first surface of an article and the second code marked on a second surface of the article; and adding, by the consensus network to a blockchain managed by the consensus network, a transaction comprising data that associates the first code with the second code.

In one example, a method comprises sending, by a computing device via a network, a list of intended recipients, in association with a first code and a second code of an article, to register the list of intended recipients in a blockchain managed by a consensus network.

In one example, a method comprises receiving, by a consensus network, a list of intended recipients, in association with a first code and a second code of an article; and adding, by the consensus network to a blockchain managed by the consensus network, a transaction to register the list of intended recipients in the blockchain.

In one example, a method comprises sending, by a computing device via a network, event data for an event performed with respect to an article, the event data specifying a code marked on the article, to register the event in a blockchain managed by a consensus network.

In one example, a method comprises receiving, by a consensus network, event data for an event performed with respect to an article, the event data specifying a code marked on the article; and adding, by the consensus network to a blockchain managed by the consensus network, a transaction to register the event data in the blockchain.

In one example, a method comprises sending, by a computing device via a network, a request for attestation of authenticity of an article by a consensus network that stores, in a blockchain, a transaction data for events performed with respect to the article, the request specifying a code marked on the article; receiving, by the computing device via the network responsive to the request, an indication of whether the consensus network attests to the article; and outputting, by the computing device for output via a display device to a user, the indication.

In one example, a method comprises receiving, by a consensus network, event data for an event performed with respect to an article, the event data specifying a code marked on the article; and adding, by the consensus network to a blockchain managed by the consensus network, a transaction to register the event data in the blockchain.

In one example, a method comprises sending, by a computing device via a network, a request for attestation of authenticity of an article by a consensus network that stores, in a blockchain, a transaction data for events performed with respect to the article, the request specifying a code marked on the article; receiving, by the computing device via the network responsive to the request, an indication of whether the consensus network attests to the article; and outputting, by the computing device for output via a display device to a user, the indication.

In one example, a method comprises by a consensus network that stores, in a blockchain, a transaction data for events performed with respect to an article, receiving a request for attestation of authenticity of the article, the request specifying a code marked on the article; determining, by the consensus network based on the transaction data stored in the blockchain, whether to attest to the authenticity of the article; and outputting, by the consensus network, an indication of whether the consensus network attests to the authenticity of the article.

In one example, an article attestation system is configured to perform methods described herein.

In one example, an article attestation system is configured to attest to the authenticity of any of the articles described herein.

Also described herein are non-transitory computer readable media, computing systems, and apparatuses configured to perform any of the methods described in this disclosure.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIGS. 1A-1B illustrate diagrams of an article according to multiple views, in accordance with techniques described herein.

FIG. 2 illustrates diagrams of an article according to multiple views, in accordance with techniques described herein.

FIG. 3 is a block diagram depicting an article attestation system for attesting to events performed with respect to an article, according to techniques described in this disclosure.

FIG. 4 is a block diagram illustrating an example of computing device, according to techniques of this disclosure.

FIG. 5 is a block diagram illustrating an example computing system, according to techniques of this disclosure.

FIG. 6 illustrates an example application of an article, according to techniques herein.

FIG. 7 is a flowchart illustrating operations for using an article for attestation in a supply chain, according to techniques of this disclosure.

FIG. 8 is flowchart illustrating an example mode of operation for a consensus network, according to techniques of this disclosure.

FIG. 9 is flowchart illustrating an example mode of operation for a consensus network, according to techniques of this disclosure.

FIG. 10 is flowchart illustrating an example mode of operation for a consensus network, according to techniques of this disclosure.

### DETAILED DESCRIPTION

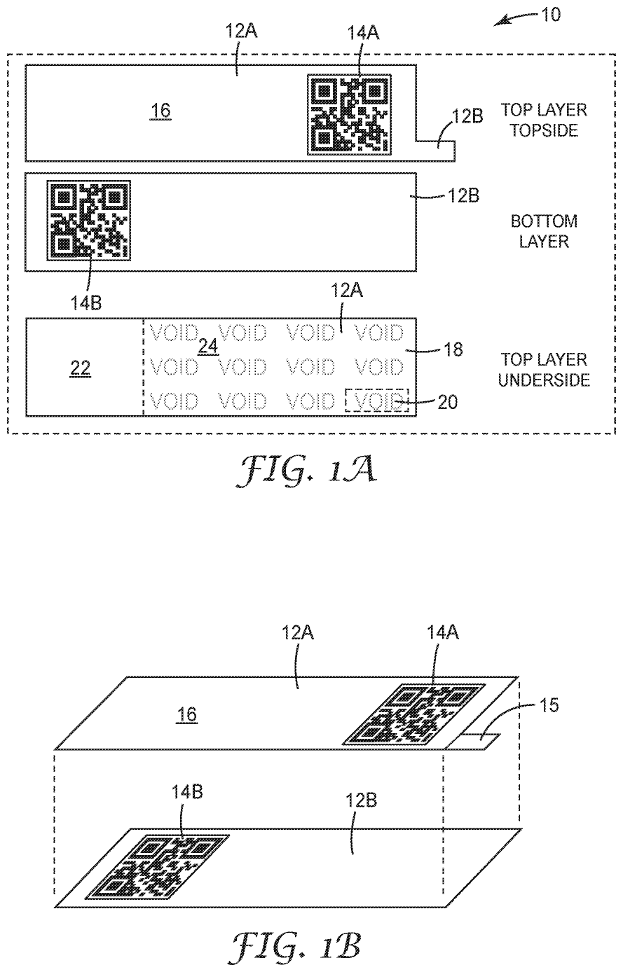

FIGS. 1A-1B are diagrams of an article according to multiple views, in accordance with techniques described herein. Article 10 may represent a label, tape, sticker, or other device. Article 10 may include at least one adhesive or cling-film layer to affix to an item. Article 10 may be inserted within a transparent envelope. As described in further detail below, article 10 may be a tamper-resistant tape or label that demonstrates evidence of tampering, if any.

Article 10 in this example includes multiple layers 12A-12B marked with or otherwise presenting respective, unique codes 14A-14B embodied thereon. FIG. 1A illustrates the top, first surface 16 of layer 12A and underside surface 18 of layer 12A, as well as the top surface of layer 12B. In the example of FIGS. 1A-1B, layers 12A-12B are a top layer that is visible and a bottom layer that is obscured by the top layer. That is, when affixed to an item, the top layer 12A may be visible with code 14A readable but the bottom layer 12B may have a top, second surface obscured by the top layer with code 14B unreadable. Layer 12B in the above examples may be visible and code 14B readable when layer 12A is removed from the layer 12B. Each code may be a unique identifier or may be associated with a unique identifier.

In some examples, however, layer 12A has a visible topside, first surface and an underside, second surface having code 14B embodied on the underside surface but not readable due to an opacity of the materials forming layer 12A. The underside surface may be made visible and code 14B readable when layer 12A is removed from an item or from remaining layers of article 10 to expose the underside surface of the layer 12A. In some instances of these examples, article 10 may have only the single layer 12A with a topside-embodied code 14A and underside-embodied code 14B. The single layer 12A may include an adhesive for adhering to an item.

At least a portion of top layer 12A may adhere to bottom layer 12B to create a multi-layered article 10. Top layer 12A includes a tag 15 that extends from top layer 12A and may not adhere to bottom layer 12B to aid in removal of the top layer 12A.

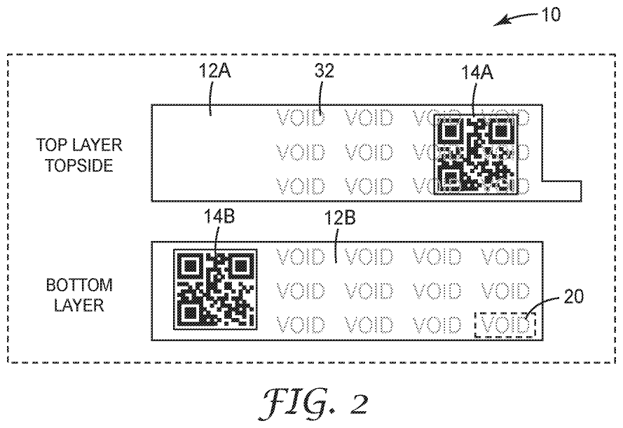

Top layer 12A may be manufactured with a tamper-evidencing pattern 20 (here, repeated “VOID” letterings) cut, impressed, or printed on at least an area 24 of the underside 18 of the top layer 12A. When top layer 12A is removed from bottom layer 12B, portions of top layer 12A included within tamper-evidencing pattern 20 remain adhered to bottom layer 12B, with the negative 32 of the tamper-evidencing pattern 20 removed from the top layer 12A, as illustrated by FIG. 2 showing layers 12A-12B of article 10 after the top layer 12A has been removed from bottom layer 12B. As seen in FIG. 2 with layer 12A having been removed from layer 12B, layer 12A has negatives 32 of the tamper-evidencing pattern 20, while layer 12B retains the tamper-evidencing pattern 20 throughout area 24.

Area 24 having the tamper-evidencing pattern 20 may include at least some of the area directly underneath the code 14A. In some cases and as illustrated in FIG. 2, the removal of residual tamper-evidencing pattern 20 therefore renders code 14A unreadable.

In some examples of article 10, area 22 of top layer 12A does not include tamper-evidencing pattern 20. Area 22 of top layer 12A may be an area encompassing and directly adhering to code 14B. Consequently, removal of top layer 12A does not render code 14B unreadable because the area of code 14B of bottom layer 12A does not retain any instances of tamper-evidencing pattern 20. In some examples, areas 22 and 24 of top layer 12A may be affixed to bottom layer 12B using different adhesives. In some examples, area 22 contains a protective film or coating layer to protect code 14B when affixed. An underside of bottom layer 12B (the side not affixed to the underside of top layer 12A) may include an adhesive for adhering to items.

In some examples of article 10, the bottom layer 12B may be embodied with code 14B as a result of removal, e.g., by a peeling action, of the top layer 12A from the bottom layer 12B. For example, area 22 may include a code pattern for code 14B. The code pattern may be created similarly as a tamper-evidencing pattern by cutting or impressing the code pattern into an adhesive for area 22 of the underside of top layer 12A. When top layer 12A is removed from the bottom layer 12B, the code pattern is residual on the topside of bottom layer 12B and thereby embodied thereon as code 14B. As another example, code 14B may be embodied on bottom layer 12B using appearing ink that becomes machine-readable upon exposure to light or air, e.g., as a result of removing top layer 12A from the bottom layer 12B.

Example description for tags, adhesive labels, and machine-readable codes that may be used to create instances of article 10 is found in U.S. Pat. No. 9,562,998, filed Dec. 11, 2013, which is incorporated herein by reference in its entirety. The codes 14 may be printed with infrared absorbing ink to enable an infrared camera to obtain images that can be readily processed to identify the machine-readable code. The machine-readable code may be a unique identifier within the scope of system 100. Codes 14 may each represent a string of characters, a number, a QR code, a bar code, or other optical pattern that is capable of being interpreted as unique identifiers.

FIG. 1B illustrates an underside of top layer 12A being affixed to a topside of bottom layer 12B. Affixing the top layer 12A to bottom layer 12B makes code 14B unreadable. Top layer 12A material has sufficient opacity to obscure code 14B and make code 14B unreadable by scanning devices.

In some examples, the number of layers of article 10 may vary, each layer embodied with different code. In some cases, codes or layers may having variable colors, symbols, patterns, numbers to make replication difficult. In some cases, fading ink or other material technology that changes colors or the code underneath when the layer is peeled or exposed to air/light may be used, to make the code 14A unreadable rather than by (or in addition to) using a tamper-evidencing pattern.

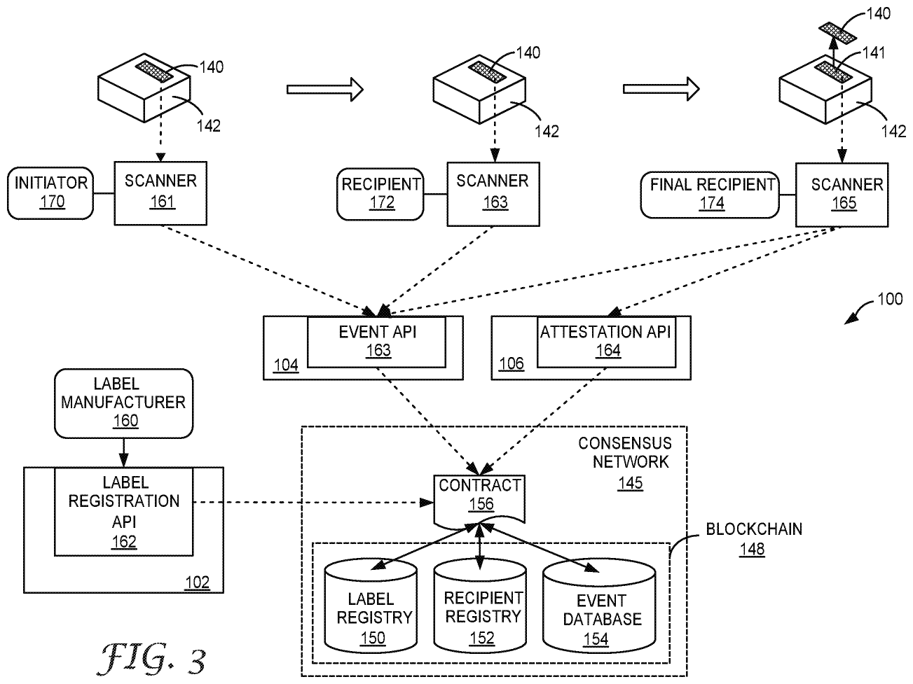

FIG. 3 is a block diagram depicting an article attestation system for attesting to events performed with respect to an article, according to techniques described in this disclosure. Article attestation system 100 in this example includes a consensus network 145 having a blockchain 148, as well as computing devices 102, 104, 106 that present respective article registration API 162, event API 163, and attestation API 164 for interacting with the consensus network 145 to register and verify transactions with the blockchain 148 using one or more smart contracts 156. Supply chain entities may use article attestation system 100 for attesting to events performed with respect to article 140, in the illustrated example.

Article 140 may represent an example of article 10 of FIGS. 1A-2. Article 140 may include at least one adhesive layer to affix article 140 to an item 142. Article 140 may be inserted within a transparent envelope. Article 140 may be a tamper-resistant tape or label that demonstrates evidence of tampering, if any, such as tampering with item 142 by, e.g., opening the item 142. Article 140 may represent a label, tape, sticker, ink, or other readable information embodied on item 142. The label, tape, or sticker may be adhesive. Article 140 may include at least one adhesive layer to affix to item 142. Article 140 may be inserted within a transparent envelope. Article 140 may be a tamper-resistant tape or label that demonstrates evidence of tampering, if any.

Item 142 represents a tangible item for which authenticity may be being validated. Item 142 may be a shipping package or other container such as a box or pill bottle for items contained therein. The article 140 may be any physical embodiment (e.g., tape, packaging for pharmaceutical product, etc.) where events performed with respect to the article or, in the case the article is a sticker or some printed or embodied marker, an item 142 to which the article is attached or embodied on, must be attested to. Article 140 including a code of a top layer may be visible on a surface of item 142.

Consensus network 145 is a network of computing devices (or “nodes”) that implement a blockchain 148. Computing devices (not shown in FIG. 3) of the consensus network may represent any computing device able to execute smart contract 156. Consensus network 145 may, for instance, represent an Ethereum network of Ethereum virtual machines (EVMs), also known as an Ethereum blockchain platform, executing on hardware computing devices.

Blockchain 148 is a shared transactional database that includes a plurality of blocks, each block (other than the root) referencing at least one block created at an earlier time, each block bundling one or more transactions registered with the blockchain 148, and each block cryptographically secured. Consensus network 145 receives transactions from transaction senders that invoke smart contract 156 to modify the blockchain 148. Consensus network 145 uses blockchain 148 for verification. Each block of blockchain 148 typically contains a hash pointer as a link to a previous block, a timestamp, and the transaction data for the transactions. By design, blockchains are inherently resistant to modification of the transaction data. Functionally, blockchain 148 serves as a distributed ledger that can record transactions between parties efficiently and in a verifiable and permanent way.

Consensus network 145 may be a peer-to-peer network that manages blockchain by collectively adhering to a protocol for validating new blocks. Once recorded, the data in any given block of blockchain 148 cannot be altered retroactively without the alteration of all subsequent blocks and a collusion of a majority of the consensus network 145. Only one blockchain 148 is illustrated for simplicity, but multiple blockchains 148 may be used with the described techniques.

Additional details regarding blockchains and applications thereof are found in the Ethereum White Paper, “A Next-Generation Smart Contract and Decentralized Application Platform”; and in “Blockchain: The Solution for Transparency in Product Supply Chains,” Nov. 21, 2015, Project Provenance Ltd.; each of which are incorporated by reference in their entireties.

Contract 156 may represent a so-called “smart contract.” Contract 156 represents an executable script or program for performing a transaction for a party, or between parties, to modify state of blockchain 148. In examples of consensus network 145 that are Ethereum networks, contract 156 represents one or more autonomous scripts or one or more stateful decentralized applications that are stored in Ethereum blockchain 148 for later execution by the nodes of consensus network 145.

Contract 156 includes operations for modifying and view transaction data registered to blockchain. Such transaction data is categorized in FIG. 3 as article registry 150, recipient registry 152, and event database 154. Blockchain 148 may store all data for article registry 150, recipient registry 152, and event database 154 to a single blockchain address, or to multiple blockchain addresses, e.g., one address per registry/database. In the case of multiple blockchain addresses, contract 156 may represent multiple corresponding contracts.

System 100 includes a network 144 to transport data communications among computing devices of system 100. Network 144 may include the Internet. Communication links between network 144 and computing devices of system 100 are omitted from FIG. 3.

System 100 includes computing devices 102, 104, and 106. Each of computing devices 102, 104, and 106 presents a different application programming interface (API) for reading or modifying blockchain 148 using contract 156. Computing devices 102, 104, and 106 may communicate with consensus network 145 to request a new blockchain 148 transaction, to read transaction data, or to request consensus network 145 to perform another operation. Computing devices 102, 104, and 106 may send and receive data via network 144 to and from consensus network 145 using JavaScript Object Notation remote procedure call (JSON-RPC), a stateless light-weight remote procedure call. JSON-RPC may operate over sockets, over HyperText Transfer Protocol, or in other message passing environments. Computing devices 102, 104, and 106 may send and receive data for APIs 162, 163, and 164 via network 144. In some cases, a computing device may execute multiple of APIs 162, 163, and 164.

Computing device 102 presents article registration API 162, which presents methods for registering an article to blockchain 148. For example, article registration API 162 may include a register method configured to receive multiple codes associated for an article. An application (not shown) executed by computing device 102 may receive data invoking the register method of article registration API 162 and including multiple codes. The application of computing device 102 may send data and the multiple codes to consensus network 145, at an address for contract 156, to invoke a register method of contract 156. The register method of contract 156 is configured to cause consensus network 145 to receive multiple codes associated for an article and create an association of the multiple codes in article registry 150 by adding at least one transaction to blockchain 148.

Accordingly, article registry 150 is an associative data store that stores, for each article of multiple articles, an association of multiple codes embodied on the article. Article manufacturer 160 manufactures articles, e.g., article 140, where each article include multiple surfaces having respective codes embodied thereon. Article manufacturer 160 may register each article by invoking the register method of article registration API 162. In addition to the multiple codes in an association for an article, the article registry 150 entry for the article may include other descriptive information for the article, such as an identifier for the manufacturer, a type of the article, dimensions of the article, text presented on the article, and so forth. Such data may be received and processed by the various methods, similarly to the codes for the article.

For example, article manufacturer 160 manufactures article 140, which includes multiple codes 141, 143 on different surfaces of the article 140. An operator, agent, or device controlled by article manufacturer 160 uses a computing device to register the multiple codes 141, 143 by invoking the register method of article registration API 162. Computing device 102, in turn, invokes the register method of contract 156 with the multiple codes. Consensus network executes the register method to add a transaction to the blockchain 148 that modifies article registry 150 to add an association of the multiple codes with one another.

Computing device 104 presents event API 163 that includes at least one method for registering expected or actual events for article 140. For example, event API 163 may include a recipients method with which an initiator 170 may register a list of intended recipients for an article, such as article 140. Event API 163 may further include an event method with which to register an event performed with respect to an article, such events including “deliver” and “receive,” for instance. Delivering and receiving may refer to relinquishing and taking custody, respectively, of the article. Applications (not shown) executed by computing device 104 respond to event API 163 invocation by invoking contract 156 to cause consensus network 145 to read or modify blockchain 148.

The recipients method of event API 163 may be configured to receive a list of identifiers for respective recipients and an identifier for an article to be received by the recipients. Identifiers may include data hashed by a private key of the recipient, addresses, or other information with which to identify a recipient of article 140. An identifier for an article may include one or more of the multiple codes for the article, or a separate identifier for looking up codes of the article, the separate identifier registered with the article in article registry 150. Computing device 104 may receive data invoking the recipients method of event API 163 and including a list of recipients and an identifier for an article. Computing device 104 may send data including the list of recipients and the identifier for the article to consensus network 145, at an address for contract 156, to invoke a recipients method of contract 156. The recipients method of contract 156 is configured to cause consensus network 145 to receive the list of recipients and the identifier for the article and store an association of the list of recipients with the identifier for the article in recipient registry 152 by adding at least one transaction to blockchain 148.

In some cases, a recipients method for event API 163 and corresponding recipients method of contract 156 permits initiator 170 to specify intended recipients on a per-code basis for an article. In other words, the recipients methods may permit initiator 170 to specify an association of a different intended recipient for each code of a multi-code article. In such cases, the recipients methods is configured to receive these associations and invoke a corresponding method of contract 156 to cause consensus network 145 to register the associations for the article in recipient registry 152 by adding at least one transaction to blockchain 148.

In some cases, the recipients methods may further permit initiator 170 to specify a range of expected times for each receipt event, a location for each receipt event, or other data that may be useful for item attestation along the supply chain.

In some cases, the initiator 170 is not the item supplier but is another party, such as the final recipient 174 or a broker.

Event API 163 may also include an event method with which to register an event performed with respect to an article. The event method is may be configured to receive an identifier of a party (e.g., recipient), an identifier for an article with respect to which an event has been or is being performed, and an event type. Example event types include “delivery” and “receipt.” Example identifiers for a party include data hashed by a private key of the recipient, addresses, or other information with which to identify a party, where a party may include initiator 170, recipient 172, or final recipient 174, for instance. Example identifiers for an article may include those described above with respect to the recipients method of event API 163.

Computing device 104 may receive data invoking the event method of event API 163 and including event data such as an identifier of a party, an identifier for an article with respect to which an event has been or is being performed, and an event type. Event data may also include, e.g., a timestamp for the event and location data indicating where the event occurred. Computing device 104 may send data including the identifier of the party, the identifier for the article, and the event type to consensus network 145, at an address for contract 156, to invoke a corresponding event method of contract 156. The event method of contract 156 is configured to cause consensus network 145 to receive event data including the identifier of the party, the identifier for the article, and the event type and to store the event data in event database 154 by adding at least one transaction to blockchain 148.

Scanners 161A-161C are computing devices coupled to machine code readers to machine-read codes for articles and invoke methods of APIs 162, 163, or, 164. Scanners 161 may be used by agents of a party to read a visible code of an article. Scanners 161 may include a QR code reader, bar code reader, or other device for reading codes 141, 143 of article 140. Other computing devices (not shown), may be used by operators or devices in order to invoke methods of APIs 162, 163, or, 164, despite not being coupled to a machine code reader.

For example, initiator 170 initiates transport of item 142 along a supply chain of multiple recipients. In the example of FIG. 3, the recipients include a single intermediate recipient 172 and final recipient 174. However, supply chains may include multiple intermediate recipients 172. Each of intermediate recipients 172 may represent a shipping company or carrier that provides transport services to initiator 170. Initiator 170 may represent an enterprise, a manufacturer, a retailer, a government agency, or another entity that sends items to a recipient using a supply chain.

Final recipient 174 is the final recipient intended by initiator 170 to receive item 142. Final recipient 174 may be a customer of initiator 170. Final recipient 174 may be an end-user or a merchant, for instance.

Initiator 170 may receive an order for item 142 from final recipient 174. Initiator 170 may select recipient 172 to transport the order for item 142. Initiator 170 may select article 140 for attestation for item 142 after obtaining article 140. An agent or device associated with initiator 170 may invoke the recipients method of event API 163 to register recipient 172 and final recipient 174, in association with article 140, to recipient registry 152. Initiator 170 may affix article 140 to item 142 for eventual delivery to final recipient 174.

Scanner 161A may scan visible code 141 of article 140 as part of delivery to recipient 172. Scanner 161A may initiate invocation of the event method of event API 163 to register a delivery event for article 140 by initiator 170. Consensus network 145 adds at least one transaction to the blockchain 148 for event database 154 with the event data for the delivery event.

Recipient 172 receives item 142 including article 140 and uses scanner 161B to scan visible code 141 of article 140. Scanner 161B may initiate invocation of the event method of event API 163 to register a receipt event for article 140 by recipient 172. Consensus network 145 adds at least one transaction to the blockchain 148 for event database 154 with the event data for the receipt event.

Final recipient 174 receives item 142 including article 140. Because final recipient 174 is the final recipient for article 140, final recipient 174 removes the top layer of article 140 embodied with code 141 to reveal code 143 of article 140. Scanner 161C may read now-visible code 143 and initiate invocation of the event method of event API 163 to register a receipt event for article 140 by final recipient 174. Consensus network 145 adds at least one transaction to the blockchain 148 for event database 154 with the event data for the receipt event. Final recipient 174 may also request attestation from consensus network 145 using attestation API 164.

Computing device 106 presents attestation API 164 by which parties may request attestation of an article, such as an article transported or in transport along a supply chain. Attestation API 164 includes an attestation method configured to receive a code for an article and return an indication of whether the consensus network 145 using blockchain 148 is able to attest to the veracity or authenticity of the article and or item protected by the article.

Computing device 106 may receive data invoking the attestation method of event API 163 and including a code for an article for which attestation is being requested. Computing device 106 may send data including the code for the article to consensus network 145, at an address for contract 156, to invoke a corresponding attestation method of contract 156. The attestation method of contract 156 is configured to cause consensus network 145 to review transactions in blockchain 148 to determine whether article 140 was received by expected recipients 172 (or expected locations) and, at least in some cases, at expected times. If so, and if article 140 does not display evidence of tampering when received by final recipient 174, this operates as evidence that item 142 (and/or items within item 142) is authentic and has not been tampered with.

As described with respect to article 10, in some examples a code 141 embodied on top layer of article 140 is rendered unreadable when the top layer is removed. As a result, it is not possible once the top layer has been removed for the article 140 to be “reinserted” into the supply chain with additional events registered to event database 154 using the code 141 embodied on the top layer. Moreover, the consensus network 145 using blockchain 148 prevents any of the parties from modifying transaction data registered in any of article registry 150, recipient registry 152, or event database 154 for blockchain 148. Consequently, attestation by consensus network 156 executing contract 156 is strongly evidenced as reliable.

Because the remaining code 143 (underside or bottom layer) for article 140 remains readable by the final recipient 174 after removal of the top layer, the final recipient 174 is able to request attestation for article 140 using code 143 by invoking the attestation method of attestation API 164 using code 143.

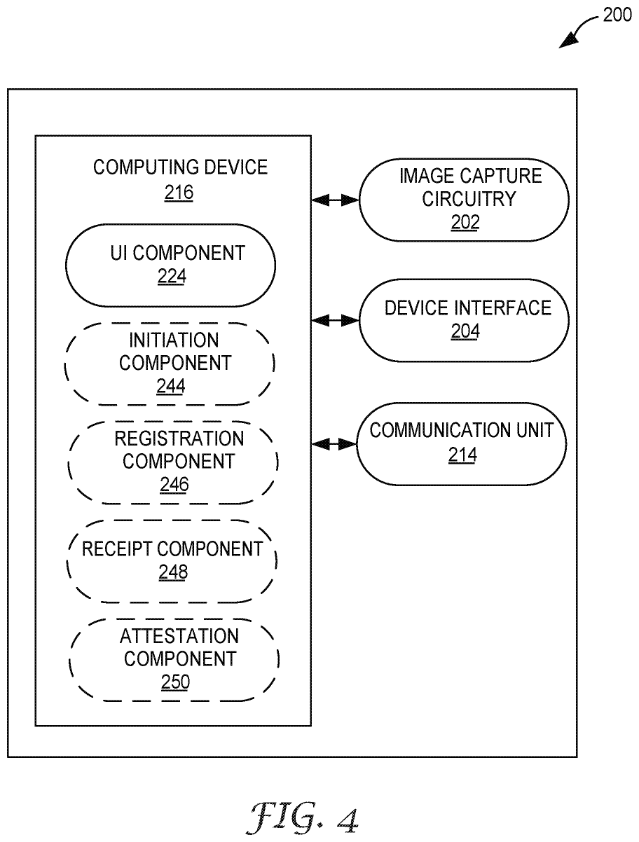

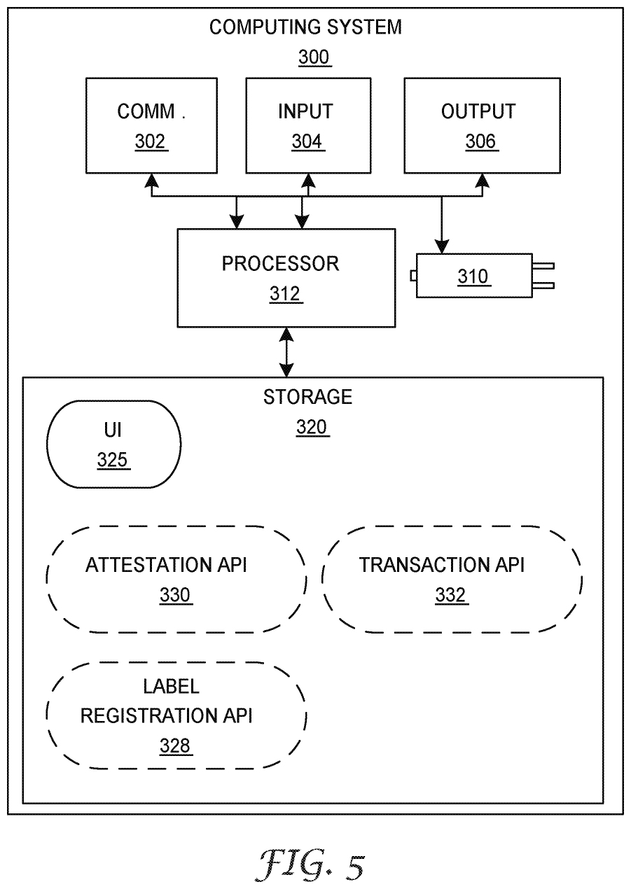

FIG. 4 is a block diagram illustrating an example of computing device, according to techniques of this disclosure. Computing device 216 may be an example of an authentication system, as described in U.S. Provisional Application No. 62/542,796, filed Aug. 8, 2017, or of one of scanners 161. U.S. Provisional Application No. 62/542,796 is incorporated by reference herein in its entirety. In the example of FIG. 4, a machine code reader may be communicatively coupled to computing device 216 via image capture circuitry 202 and/or communication unit 214. Image capture circuitry 202 may receive image information for an article code from the reader. Interpretation component 218 may interpret the image information to obtain a unique code. In some cases, communication unit 214 receives the unique code from the reader, which includes an interpretation component.

Device interface 204 may include a wired or wireless connection to a smartphone, tablet computer, laptop computer or similar device. In some examples, computing device 216 may communicate via device interface 204 for a variety of purposes such as presenting information.

In some examples, computing device 216 may communicate to external networks, e.g. network 144, via wired and/or wireless communication units 214, in order to communicate with other computing devices. That is, one or more communication units 214 of computing device 216 may communicate with external devices by transmitting and/or receiving data. For example, computing device 216 may use communication units 214 to transmit and/or receive radio signals on a radio network such as a cellular radio network or other networks, such as networks 4. Communication units 214 may include a network interface card.

Each of components (or “modules”) 218, 224, 244, 246, 248, and 250 include instructions executable by a programmable processor. Components 218, 224, 244, 246, 248, and 250 may perform operations described herein using software, hardware, firmware, or a mixture of both hardware, software, and firmware residing in and executing on computing device 216 and/or at one or more other remote computing devices. Computing device 216 may execute components 218, 224, 244, 246, 248, and 250 with one or more processors. Computing device 216 may execute any of components 218, 224, 244, 246, 248, and 250 as or within a virtual machine or container executing on underlying hardware. Components 218, 224, 244, 246, 248, and 250 may be implemented in various ways. For example, any of components 218, 224, 244, 246, 248, and 250 may be implemented as a downloadable or pre-installed application or “app”. In another example, any of components 218, 224, 244, 246, 248, and 250 may be implemented as part of an operating system of computing device 216. Components 218, 244, 246, 248, and 250 are illustrated with dashed lines to indicate that computing device 216 may include a subset of the components 244, 246, 248, and 250.

Initiation component 244 is configured to communicate with event API 163 to register a list of expected events for articles to blockchain 148. Properties of methods of event API 163 are described above with respect to FIG. 3. Initiation component 244 may cause UI component to output a user interface having user input elements for entering expected event data, such as a list of expected recipients, expected locations, expected times, and/or other expected event data for a list of events expected to be performed with respect to an article in the supply chain. Initiation component 244 may obtain an identifier for an article for associating with the event data from interpretation component 218. For example, a user may use a scanner to scan an article code, then use computing device 216 to register expected events with respect to the article. Initiation component 244 may receive event data input by a user and send the event data to computing device 104 via network 144 to invoke methods of event API 163, as described above.

Registration component 246 is configured to communicate with article registration API 162 to register articles and, more specifically, to associate multiple codes of an article to blockchain 148. Properties of methods of article registration API 162 are described above with respect to FIG. 3. An article manufacturing device of article manufacturer 160 may use computing device 216 to send data associating multiple codes for each article to invoke methods of article registration API 162, as described above.

Event component 248 is configured to communicate with event API 163 to register actual events, performed with respect to articles, to blockchain 148. Properties of methods of event API 163 are described above with respect to FIG. 3. Event component 248 may obtain an identifier for an article for associating with the event data from interpretation component 218. For example, a user may use a scanner to scan an article code, which event component 248 may register to the blockchain 148 with event data for the article via event API 163, as described above. Event component 248 may send data indicating a receipt event for an article to computing device 104 to invoke an event method of event API 163.

Attestation component 250 is configured to communicate with attestation API 164 to request attestation of articles. Properties of methods of attestation API 164 are described above with respect to FIG. 3. Attestation component 250 may obtain an identifier for an article for associating with the event data from interpretation component 218. For example, a user may use a scanner to scan an article code, which attestation component 250 may send to attestation API 164 to request attestation, as described above. Attestation component 250 may receive, from computing device 106, an indication of whether the consensus network 145 using blockchain 148 is able to attest to the veracity or authenticity of the article and or item protected by the article. Attestation component 250 may cause UI component 224 to output, for display to a user, the indication. In this way, a user of computing device 216 may receive evidence of whether an article is original and has been tampered with.

FIG. 5 is a block diagram illustrating an example computing system, according to techniques of this disclosure. Computing system 300 of FIG. 5 is described below as an example or alternate implementation of any one or more of computing devices 102, 104, 106 of FIG. 3. Other examples may be used or may be appropriate in some instances. Although computing system 300 may be a stand-alone device, computing system 300 may take many forms, and may be, or may be part of, any component, device, or system that includes a processor or other suitable computing environment for processing information or executing software instructions. In some examples, computing system 300, or components thereof, may be fully implemented as hardware in one or more devices or logic elements. Computing system 300 may represent multiple computing servers operating as a distributed system to perform the functionality described. A similar computing system as system 300 may be used to implement computing device 216.

Computing system 300 may include one or more communication units 302, one or more input devices 304, one or more output devices 306, power source 310, one or more processors 312, and one or more storage devices 320. One or more storage devices 320 may store user interface module 325, attestation API 330, event API 332, and article registration API 328. Attestation API 330, event API 332, and article registration API 328 are depicted with dashed lines to indicate computing system 300 may include a subset of these modules 330, 332, 328. One or more of the devices, modules, storage areas, or other components of computing system 300 may be interconnected to enable inter-component communications (physically, communicatively, and/or operatively). In some examples, such connectivity may be provided by through system bus, a network connection, an inter-process communication data structure, or any other method for communicating data.

One or more input devices 304 of computing system 300 may generate, receive, or process input. Such input may include input from a keyboard, pointing device, voice responsive system, video camera, biometric detection/response system, button, sensor, mobile device, control pad, microphone, presence-sensitive screen, network, or any other type of device for detecting input from a human or machine. One or more output devices 306 of computing system 300 may generate, transmit, or process output. Examples of output are tactile, audio, visual, and/or video output. Output devices 306 may include a display, sound card, video graphics adapter card, speaker, presence-sensitive screen, one or more USB interfaces, video and/or audio output interfaces, or any other type of device capable of generating tactile, audio, video, or other output. Output devices 306 may include a display device, which may function as an output device using technologies including liquid crystal displays (LCD), quantum dot display, dot matrix displays, light emitting diode (LED) displays, organic light-emitting diode (OLED) displays, cathode ray tube (CRT) displays, e-ink, or monochrome, color, or any other type of device for generating tactile, audio, and/or visual output. In some examples, computing system 300 may include a presence-sensitive display that may serve as a user interface device that operates both as one or more input devices 304 and one or more output devices 306.

One or more communication units 302 of computing system 300 may communicate with devices external to computing system 300 by transmitting and/or receiving data, and may operate, in some respects, as both an input device and an output device. In some examples, one or more communication units 302 may communicate with other devices over a network, e.g., network 144. In other examples, one or more communication units 302 may send and/or receive radio signals on a radio network such as a cellular radio network. In other examples, one or more communication units 302 of application server 206 may transmit and/or receive satellite signals on a satellite network such as a Global Positioning System (GPS) network. Examples of one or more communication units 302 may include a network interface card (e.g. such as an Ethernet card), an optical transceiver, a radio frequency transceiver, a GPS receiver, or any other type of device that can send and/or receive information. Other examples of one or more communication units 302 may include Bluetooth®, GPS, 3G, 4G, and Wi-Fi® radios found in mobile devices as well as Universal Serial Bus (USB) controllers and the like.

One or more processors 312 of computing system 300 may implement functionality and/or execute instructions associated with computing system 300. Examples of one or more processors 312 may include microprocessors, application processors, display controllers, auxiliary processors, one or more sensor hubs, and any other hardware configured to function as a processor, a processing unit, or a processing device. Computing system 300 may use one or more processors 312 to perform operations in accordance with one or more aspects of the present disclosure using software, hardware, firmware, or a mixture of hardware, software, and firmware residing in and/or executing at computing system 300.

One or more storage devices 320 within computing system 300 may store information for processing during operation of computing system 300. In some examples, one or more storage devices 320 are temporary memories, meaning that a primary purpose of the one or more storage devices is not long-term storage. One or more storage devices 320 on computing system 300 may be configured for short-term storage of information as volatile memory and therefore not retain stored contents if deactivated. Examples of volatile memories may include random access memories (RAM), dynamic random-access memories (DRAM), static random-access memories (SRAM), and other forms of volatile memories known in the art. One or more storage devices 320, in some examples, also include one or more computer-readable storage media. One or more storage devices 320 may be configured to store larger amounts of information than volatile memory. One or more storage devices 320 may further be configured for long-term storage of information as non-volatile memory space and retain information after activate/off cycles. Examples of non-volatile memories may include magnetic hard disks, optical discs, floppy disks, Flash memories, or forms of electrically programmable memories (EPROM) or electrically erasable and programmable (EEPROM) memories. One or more storage devices 320 may store program instructions and/or data associated with one or more of the modules described in accordance with one or more aspects of this disclosure.

One or more processors 312 and one or more storage devices 320 may provide an operating environment or platform for one or one more modules, which may be implemented as software, but may in some examples include any combination of hardware, firmware, and software. One or more processors 312 may execute instructions and one or more storage devices 320 may store instructions and/or data of one or more modules. The combination of one or more processors 312 and one or more storage devices 320 may retrieve, store, and/or execute the instructions and/or data of one or more applications, modules, or software. One or more processors 312 and/or one or more storage devices 320 may also be operably coupled to one or more other software and/or hardware components, including, but not limited to, one or more of the components illustrated in FIG. 5.

One or more modules illustrated in FIG. 5 as being included within one or more storage devices 320 (or modules otherwise described herein) may perform operations described using software, hardware, firmware, or a mixture of hardware, software, and firmware residing in and/or executing at computing system 300. Computing system 300 may execute each of the module(s) with multiple processors or multiple devices. Computing system 300 may execute one or more of such modules as a virtual machine or container executing on underlying hardware. One or more of such modules may execute as one or more services of an operating system or computing platform. One or more of such modules may execute as one or more executable programs at an application layer of a computing platform.

Article registration API 328 for execution by processors 312 presents an API that may be invoked by other devices communicating with computing system 300. Article registration API 328 may be an example implementation of article registration API 162. Properties of methods of article registration API 328 are described above with respect to article registration API 162 of FIG. 3. Article registration API 328 may store a blockchain address for contract 156 to invoke methods of contract 156 for registering associations of multiple codes of articles to article registry 150 implemented by blockchain 148.

Event API 332 for execution by processors 312 presents an API that may be invoked by other devices communicating with computing system 300. Event API 332 may be an example implementation of event API 163. Properties of methods of article registration API 328 are described above with respect to event API 163 of FIG. 3. Event API 332 may store a blockchain address for contract 156 to invoke methods of contract 156 for registering expected and actual events to recipient registry 152 and event database 154 implemented by blockchain 148.

Attestation API 330 for execution by processors 312 presents an API that may be invoked by other devices communicating with computing system 300. Attestation API 330 may be an example implementation of attestation API 164. Properties of methods of attestation API 330 are described above with respect to attestation API 164 of FIG. 3. Attestation API 330 may store a blockchain address for contract 156 to invoke methods of contract 156 for requesting attestation of an article using data stored to article registry 150, recipient registry 152, and event database 154 implemented by blockchain 148.

User interface (UI) module 325 for execution by processors 312 outputs, for display via output device(s) 306, a user interface to enable an operator to configure configuration data for any of attestation API 330, event API 332, and article registration API 328. For example, an operator may configure a blockchain address for contract 156 using UI module 325.

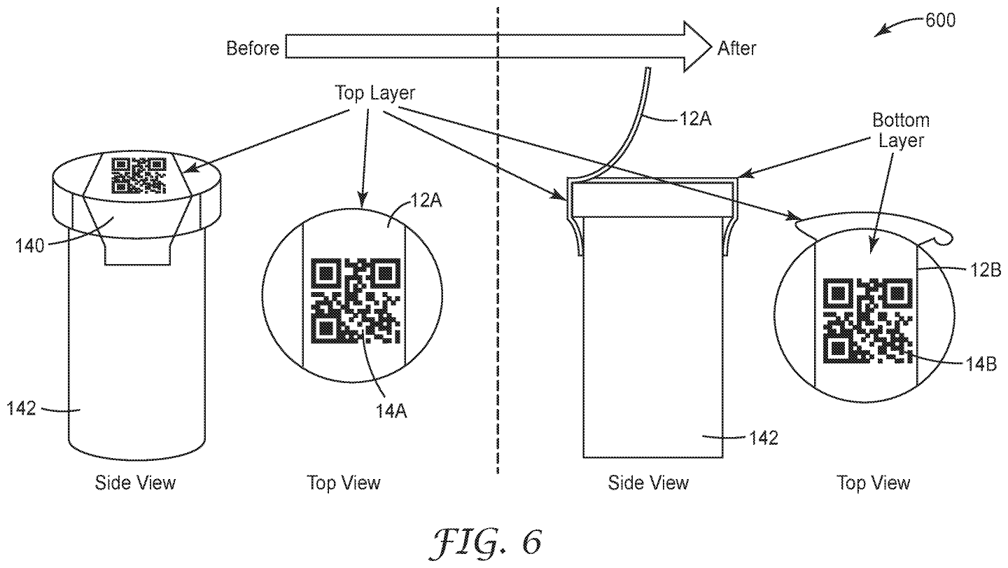

FIG. 6 illustrates an example application of an article, according to techniques herein. Code 14A of top layer 12A is initially visible. A user peels off top layer 12A of article 10 affixed to item 142 to reveal bottom layer 12B and code 14B, which can be read by a reader and used for attestation of article 10 and, by extension, item 142.

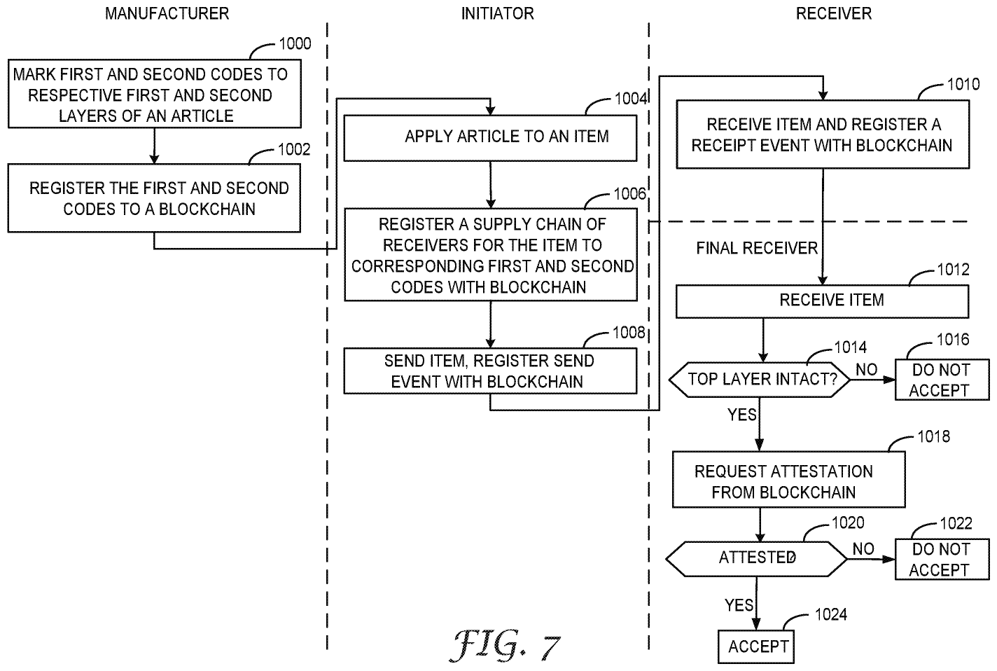

FIG. 7 is a flowchart illustrating operations for using an article for attestation in a supply chain, according to techniques of this disclosure. The operations are described with respect to elements of system 100 of FIG. 3 but may be applied by systems having different architectures. A manufacturer 160 manufactures an article 140 having a top layer and a bottom layer and embodies the top and bottom layer with respective codes 141, 143 (1000). In some examples, the manufacturer may embody the codes on opposite surfaces of a single layer. The manufacturer 160 uses a device to invoke article registration API 162 of computing device 102 to cause consensus network 145 executing contract 156 to register an association of codes 141, 143 to blockchain 148, in article registry 150 (1002).

An initiator 170 obtains the article 140 and may apply article 140 to an item 142, e.g., by affixing the article 140 to the item 142 (1004). Article 140 may operate as a seal for item 142 in cases where item 142 is a container. Initiator 170 uses a device to invoke event API 163 of computing device 104 to register expected receivers of a supply chain for item 142 and associate the expected receivers with corresponding codes 141, 143 (1006). For example, initiator 170 may associate final recipient 174 with code 143 and other one or more intermediate receivers with code 141. The initiator 170 may send the item 142, i.e., deliver the item 142 to the supply chain, and use a device to invoke event API 163 to register a deliver event for article 140 to blockchain 148, in event database 154 (1008).

Recipient 172 receives item 142 including article 140 and uses a device to invoke event API 163 to register a receipt event for article 140 by recipient 172 to blockchain 148, in event database 154 (1010).

Final recipient 174 receives item 142 including article 140 (1012). Final recipient 174 inspects the article 140 to determine whether the top layer has been removed or otherwise tampered with. If the top layer has been tampered with (NO branch of 1014), final recipient 174 may not accept the item 142 (1016).

Otherwise (YES branch of 1014), final recipient 174 may use a device to invoke attestation API 164 to request attestation for article 140 (1018). Attestation API 164 returns an indication of whether the consensus network 145 using blockchain 148 is able to attest to the veracity or authenticity of the article 140. If the article 140 is attested (YES branch of 1020), final recipient 174 may accept the item 142 as original, untampered with, or otherwise conforming to what was originally placed into the supply chain by the initiator 170 (1024). Otherwise (NO branch of 1020), final recipient 174 may not accept the item 142 (1022).

In some cases, cryptocurrency may be used to incent workers to distance from fraud. In such cases, as an example, an event transaction that is attested to by consensus network 145 using blockchain 148 may trigger a transaction to credit currency to an account associated with a worker managing the scanner 161 that initiated the event transaction. In some cases, a review system may allow recipients to review products and services. In some cases, the techniques may be combined with RFID technology. In some case, the techniques may be applied in conjunction with passwords, fingerprint scans or other personnel verification schemes.

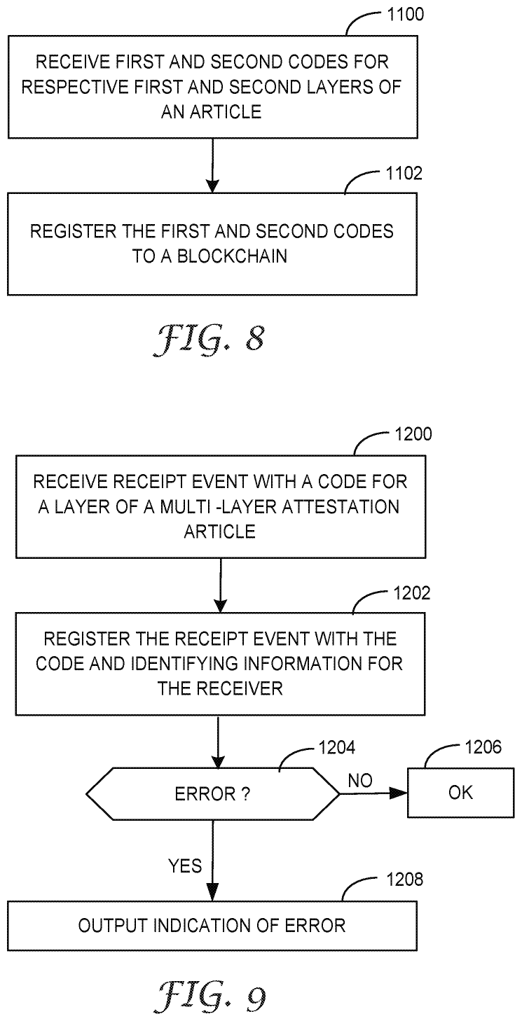

FIG. 8 is flowchart illustrating an example mode of operation for a consensus network, according to techniques of this disclosure. The operations are described with respect to elements of system 100 of FIG. 3 but may be applied by systems having different architectures.

Blockchain 148 stores a smart contract 156 at a blockchain address. A node of consensus network 145 receives data at the blockchain address invoking a register method of the smart contract 156. The data includes first and second codes for first code 141 and second code 143 of respective layers of an article 140 manufactured as described herein (1100). The consensus network 145 executes the register method of smart contract 156 to add a transaction to blockchain 148, in article registry 150, that associates the first code 141 and second code 143 (1102).

FIG. 9 is flowchart illustrating an example mode of operation for a consensus network, according to techniques of this disclosure. The operations are described with respect to elements of system 100 of FIG. 3 but may be applied by systems having different architectures.

Blockchain 148 stores a smart contract 156 at a blockchain address. A node of consensus network 145 receives data at the blockchain address invoking an event method of the smart contract 156. The data includes an identifier for code 141 and may indicate a receipt event (1200).

The consensus network 145 executes the event method to register the receipt event (1202). The consensus network 145 may also attempt to attest to article 140 using the transactions stored by the blockchain 148, as article registry 150 and recipient registry 152. Consensus network 145 may query recipient registry 152 to identify expected events. Consensus network 145 then attempts to determine whether the new receipt event indicates an unexpected recipient, location, or time for the new receipt event. If so (YES branch of 1204), consensus network 145 may return an indication of error to the requestor invoking the event method of smart contract 156, e.g., computing device 104 (1204). Otherwise (NO branch of 1204), consensus network 145 may return an indication of error to the requestor invoking the event method of smart contract 156 or take no action with respect to the attestation (1208).

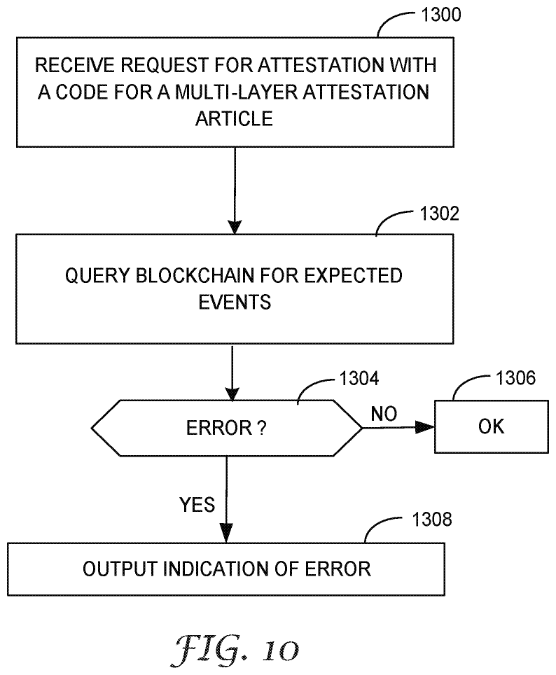

FIG. 10 is flowchart illustrating an example mode of operation for a consensus network, according to techniques of this disclosure. The operations are described with respect to elements of system 100 of FIG. 3 but may be applied by systems having different architectures.

Blockchain 148 stores a smart contract 156 at a blockchain address. A node of consensus network 145 receives data at the blockchain address invoking an attestation method of the smart contract 156. The data includes an identifier for code 143 for article 140 (1300).

Consensus network 145 executes the attestation method to query recipient registry 152 and event database 154 of the blockchain 148 to identify expected events (1302). Consensus network 145 then attempts to determine whether any of the events indicates an unexpected recipient, location, or time for the event. If so (YES branch of 1304), consensus network 145 may return an indication of successful attestation to the requestor invoking the attestation method of smart contract 156, e.g., computing device 106 (1308). Otherwise (NO branch of 1304), consensus network 145 may return an indication of error to the requestor invoking the attestation method of smart contract 156 (1306).

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor”, as used may refer to any of the foregoing structure or any other structure suitable for implementation of the techniques described. In addition, in some aspects, the functionality described may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

It is to be recognized that depending on the example, certain acts or events of any of the methods described herein can be performed in a different sequence, may be added, merged, or left out altogether (e.g., not all described acts or events are necessary for the practice of the method). Moreover, in certain examples, acts or events may be performed concurrently, e.g., through multi-threaded processing, interrupt processing, or multiple processors, rather than sequentially.

In some examples, a computer-readable storage medium includes a non-transitory medium. The term “non-transitory” indicates, in some examples, that the storage medium is not embodied in a carrier wave or a propagated signal. In certain examples, a non-transitory storage medium stores data that can, over time, change (e.g., in RAM or cache).

Various examples of the disclosure have been described. These and other examples are within the scope of the following claims.

What is claimed is:

1. An article comprising:
a layer having a first surface marked with a first code; and
a second surface marked with a second code, the second code obscured by the layer to be unreadable through the layer,
wherein the first code and the second code are associated in transaction data stored by a blockchain managed by a consensus network of nodes.

2. The article of claim 1 or 13, wherein the first surface is a topside of the layer and the second surface is an underside of the layer.

3. The article of claim 1 or 13, further comprising:
a second layer having the second surface,
wherein the layer comprises a first layer and is adhered to the second surface.

4. The article of claim 3, wherein an underside of the first layer that is adhered to the second layer comprises:
a first area having a tamper-evidencing pattern; and
a second area that does not have a tamper-evidencing pattern, wherein the second area encompasses and adheres to the second code.

5. The article of claim 4,
wherein an area of the second layer adhered to the first area retains the tamper-evidencing pattern when the first area is removed from the second layer,
wherein the second code does not retain a tamper-evidencing pattern and is readable on removal of the second area from the second code.

6. The article of claim 3, wherein the first layer comprises a tamper-evidencing pattern configured to indicate whether the first layer has been removed from the second layer.

7. The article of claim 3, wherein the first layer is configured to make the first code unreadable to a reader if the first layer is at least partially removed from the second layer.

8. The article of claim 1 or 13, wherein the first code comprises one of a quick response (QR) code and a bar code.

9. The article of claim 1 or 13,
wherein the article comprises one of adhesive tape and an adhesive label, and
wherein when the article is affixed to a surface the first code is visible.

10. The article of claim 1 or 13, wherein the article is affixable to an item that is a container of items to be attested.

11. The article of claim 1 or 13, further comprising:
a second layer, wherein the layer comprises a first layer having an underside adhered to the second layer, wherein the underside of the first layer is the second surface and is embodied with a code pattern for the second code,
wherein removal of the first layer from the second layer causes the second layer to become marked with the second code.

12. The article of claim 1 or 13, further comprising:
a second layer having the second surface,
wherein the layer comprises a first layer and is adhered to the second surface,
wherein removal of the first layer from the second layer causes the second code to become readable.

13. An article comprising:
a layer having a first surface marked with a first code; and
a second surface marked with a second code, the second code obscured by the layer to be unreadable through the layer.

14. A method comprising:
marking a first surface of a layer of an article with a first code;
marking a second surface of the article with a second code, the second code obscured by the layer and unreadable through the layer; and
sending, by a computing device via a network, the first code and the second code to register an association of the first code and the second code in a blockchain managed by a consensus network.

15. The method of claim 14, wherein the sending comprises:
sending, by the computing device to an interface of an executing application, the first code and the second code.

16. The method of claim 14, wherein the article comprises the article of any of claims 1-13.

17. A method comprising:
receiving, by a consensus network, a first code and a second code, the first code marked on a first surface of an article and the second code marked on a second surface of the article; and
adding, by the consensus network to a blockchain managed by the consensus network, a transaction comprising data that associates the first code with the second code.

18. The method of claim 17,
wherein the blockchain comprises a smart contract configured with a method that, when executed by the consensus network, causes the consensus network to perform the receiving and the adding.

19. The method of claim 17, wherein the article comprises the article of any of claims 1-13.

20. A method comprising:
sending, by a computing device via a network, a list of intended recipients, in association with a first code and a second code of an article, to register the list of intended recipients in a blockchain managed by a consensus network.

21. The method of claim 20, wherein each recipient in the list of intended recipients comprises one or more of:
an identifier for the recipient;
an expected location at which the recipient is to receive the article; and
an expected time range at which the recipient is to receive the article.

22. The method of claim 20,
wherein a first recipient from the list of intended recipients is in association with the first code, and
wherein a second recipient from the list of intended recipients is in association with the second code.

23. The method of claim 20, wherein the article comprises the article of any of claims 1-13.

24. A method comprising:
receiving, by a consensus network, a list of intended recipients, in association with a first code and a second code of an article; and
adding, by the consensus network to a blockchain managed by the consensus network, a transaction to register the list of intended recipients in the blockchain.

25. The method of claim 24, wherein each recipient in the list of intended recipients comprises one or more of:
an identifier for the recipient;
an expected location at which the recipient is to receive the article; and
an expected time range at which the recipient is to receive the article.

26. The method of claim 24,
wherein a first recipient from the list of intended recipients is in association with the first code, and
wherein a second recipient from the list of intended recipients is in association with the second code.

27. The method of claim 24,
wherein the blockchain comprises a smart contract configured with a method that, when executed by the consensus network, causes the consensus network to perform the receiving and the adding.

28. The method of claim 24, wherein the article comprises the article of any of claims 1-13.

29. A method comprising:
sending, by a computing device via a network, event data for an event performed with respect to an article, the event data specifying a code marked on the article, to register the event in a blockchain managed by a consensus network.

30. The method of claim 29, wherein the event data specifies the event is one of a delivery event and a receipt event.

31. The method of claim 29, wherein the event data comprises one or more of:
an identifier for a recipient of the article that has performed a receipt event with respect to the article;
a location at which the receipt event occurred; and
a time at which the receipt event occurred.

32. The method of claim 29,
wherein the article comprises the article of any of claims 1-13, and
wherein the code comprises one of the first code and the second code.

33. A method comprising:
receiving, by a consensus network, event data for an event performed with respect to an article, the event data specifying a code marked on the article; and
adding, by the consensus network to a blockchain managed by the consensus network, a transaction to register the event data in the blockchain.

34. The method of claim 33, wherein the event data comprises one or more of:
an identifier for a recipient of the article that has performed a receipt event with respect to the article;
a location at which the receipt event occurred; and
a time at which the receipt event occurred.

35. The method of claim 33,
wherein the article comprises the article of any of claims 1-13, and
wherein the code comprises one of the first code and the second code.

36. The method of claim 33,
wherein the blockchain comprises a smart contract configured with a method that, when executed by the consensus network, causes the consensus network to perform the receiving and the adding.

37. A method comprising:
sending, by a computing device via a network, a request for attestation of authenticity of an article by a consensus network that stores, in a blockchain, a transaction data for events performed with respect to the article, the request specifying a code marked on the article;
receiving, by the computing device via the network responsive to the request, an indication of whether the consensus network attests to the article; and
outputting, by the computing device for output via a display device to a user, the indication.

38. The method of claim 37,
wherein the article comprises the article of any of claims 1-13, and
wherein the code comprises one of the first code and the second code.

39. A method comprising:
by a consensus network that stores, in a blockchain, a transaction data for events performed with respect to an article, receiving a request for attestation of authenticity of the article, the request specifying a code marked on the article;
determining, by the consensus network based on the transaction data stored in the blockchain, whether to attest to the authenticity of the article; and
outputting, by the consensus network, an indication of whether the consensus network attests to the authenticity of the article.

40. The method of claim 39, wherein the determining comprises:
determining, by the consensus network based on a list of recipients registered in the blockchain and a list of events registered in the blockchain, whether the list of events correspond to the list of recipients.

41. The method of claim 40, wherein each recipient in the list of intended recipients comprises one or more of:
an identifier for the recipient;
an expected location at which the recipient is to receive the article; and
an expected time range at which the recipient is to receive the article.

42. The method of claim 39,
wherein the blockchain comprises a smart contract configured with a method that, when executed by the consensus network, causes the consensus network to perform the receiving, determining, and outputting.

43. The method of claim 39,
wherein the article comprises the article of any of claims 1-13, and
wherein the code comprises one of the first code and the second code.

44. An article attestation system configured to perform the methods of any of claims 14-43.

45. An article attestation system configured to attest to the authenticity of any of the articles of claims 1-13.

46. A non-transitory computer readable medium, computing system, or apparatus configured to perform any of the methods described in this disclosure.
